(19) United States
(12) Patent Application Publication
(10) Pub. No.: US 2012/0192214 A1
(43) Pub. Date: Jul. 26, 2012

(54) METHOD AND APPARATUS FOR DELIVERING TARGETED CONTENT TO TELEVISION VIEWERS

(75) Inventors: Andreas Hunn, Leesburg, VA (US); Nicolas Tabbal, Vienna, VA (US); Sara Taylor, Arlington, VA (US); John Brady, Alexandria, VA (US)

(73) Assignee: Resonate Networks, Reston, VA (US)

(21) Appl. No.: 13/365,020

(22) Filed: Feb. 2, 2012

Related U.S. Application Data
(63) Continuation-in-part of application No. 12/942,469, filed on Nov. 9, 2010.
Application No. 12/942,469 is a continuation-in-part of application No. 12/644,892, filed on Dec. 22, 2009.
(60) Provisional application No. 61/509,683, filed on Jul. 20, 2011.

(51) Int. Cl. H04N 21/258

(52) U.S. Cl. 725/9

(57) ABSTRACT

A method of selecting a television channel or program for delivery of targeted content to an audience member television display based on attitude values associated with audience members who participate in a computer implemented survey is disclosed. The survey response information, as well as television viewing information, and demographic information associated with the audience members may be collected and stored in a central database. An attitude value may be determined from the survey response information and/or the other information for the audience members. The attitude value may indicate the audience member's view about an issue, topic, product, service or the like. The attitude value in conjunction with other television viewing information may be used to select a television channel or program for delivery of the targeted content to the audience members.

### CROSS REFERENCE TO RELATED APPLICATIONS

The present application relates to, is a continuation in part of, and claims the benefit or earlier filed U.S. patent application Ser. No. 12/942,469 filed Nov. 9, 2010 and entitled Method And Apparatus For Delivering Targeted Content To Website Visitors To Promote Products And Brands, which relates to, and is a continuation in part of, and claims the benefit or earlier filed U.S. patent application Ser. No. 12/644,892 filed Dec. 22, 2009 and entitled Method and Apparatus for Delivering Targeted Content to Website Visitors, and relates to, and claims the priority of Provisional Patent Application No. 61/509,683 filed Jul. 20, 2011 and entitled Method and Apparatus for Delivering Targeted Content to Television Viewers.

### FIELD OF THE INVENTION

The present invention relates to methods and apparatus for determining one or more optimal television channels or programs on which to display targeted content to a plurality of television viewers, referred to as audience members.

### BACKGROUND OF THE INVENTION

The television is used by advertisers and other content providers to deliver content, including but not limited to advertisements, to television audience members. Audience members may be individual human beings, a group of human beings, such as those who reside in a common household, and/or a device associated with an individual human being or a group of human beings, such as, but not limited to a device or computer which utilizes an Internet browser.

There is a continuing need to deliver targeted content, meaning content that may be of particular interest to some but not all audience members, to audience members with particular attitudes or views in order to selectively promote products, services and/or brands. The ability of content providers and advertisers to select optimal television programs or channels for the delivery of targeted content to audience members with particular attitudes has been limited. Further, content providers and advertisers have been unable to select television programs or channels for the delivery of targeted content which are both likely to be viewed by audience members with particular attitudes and/or values while at the same time unlikely to be viewed by audience members with opposing attitudes and/or values. Accordingly, there is a need for improved methods and systems for delivering targeted content to audience members.

It is an advantage of some, but not necessarily all, embodiments of the present invention to provide methods and systems for selecting television channels for the delivery of or display of targeted content to audience members who are likely to have particular attitudes and/or values. It is also an advantage of some, but not necessarily all, embodiments of the present invention to provide methods and systems for selecting television channels for the delivery of or display of targeted content which are less likely to be viewed by audience members who have opposing attitudes and/or values to those of the audience members to whom it is desired to deliver the targeted content.

Additional advantages of various embodiments of the invention are set forth, in part, in the description that follows and, in part, will be apparent to one of ordinary skill in the art from the description and/or from the practice of the invention.

### SUMMARY OF THE INVENTION

Responsive to the foregoing challenges, Applicants have developed an innovative method of transmitting content for viewing on a television display associated with an audience member based on attitude values determined for audience members who participate in a computer implemented survey, and television viewing information and demographic information for the audience members, the method comprising: receiving at a central database survey response information transmitted over a computer network from participating audience member computers; receiving at the central database television viewing information for the participating audience members; receiving at the central database demographic information which is associated with the (i) participating audience members, and (ii) non-participating audience members from whom no survey response information is received; determining information selected from the group consisting of: Value Orientation information, Purchase Category information, Purchase Orientation information, Brand Attribute information, Purchase Engagement information, Shopping Engagement information, Corporate Involvement information, Issue Question information, Political Orientation information, Voting History information, Party Affiliation information, and Level of Engagement information from the survey response information; determining an attitude value for each of the participating audience members using a non-audience member computer based at least in part on one or more of the Value Orientation information, Purchase Category information, Purchase Orientation information, Brand Attribute information, Purchase Engagement information, Shopping Engagement information, Corporate Involvement information, Issue Question information, Political Orientation information, Voting History information, Party Affiliation information, and Level of Engagement information; determining a Quality Visitation Index (QVI) value for a television channel or television program from the television viewing information and attitude values using the non-audience member computer; providing content to TV service providers for the television channel or television program based on the QVI value for the television channel or television program; and transmitting the content to a television display associated with one of said participating or non-participating audience members.

Applicants have further developed an innovative method of determining content for display on a television display associated with an audience member, the method comprising: receiving at a central database survey response information transmitted over a computer network from participating audience member computers; receiving at the central database television viewing information for the participating audience members; receiving at the central database demographic information which is associated with the (i) participating audience members, and (ii) non-participating audience members from whom no survey response information is received; determining information selected from the group consisting of: Value Orientation information, Purchase Category information, Purchase Orientation information, Purchase Engagement information, Brand Attribute information, Shopping Engagement information, Corporate Involvement information, Issue Question information, Political Orientation information, Voting History information, Party Affiliation information, and Level of Engagement information from the survey response information; determining an attitude value for each of the participating audience members based at least in part on one or more of the Value Orientation information, Purchase Category information, Purchase Orientation information, Brand Attribute information, Purchase Engagement information, Shopping Engagement information, Corporate Involvement information, Issue Question information, Political Orientation information, Voting History information, Party Affiliation information, and Level of Engagement information; determining a Quality Visitation Index (QVI) value for a television channel or program from the television viewing information and attitude values; and providing content for display on the television channel or program based on the QVI value for the television channel or program.

It is to be understood that both the foregoing general description and the following detailed description are exemplary and explanatory only, and are not restrictive of the invention as claimed.

### BRIEF DESCRIPTION OF THE DRAWINGS

In order to assist the understanding of this invention, reference will now be made to the appended drawings, in which like reference characters refer to like elements.

FIG. 1 is a schematic diagram of a computer network configured in accordance with a first embodiment of the present invention.

FIG. 1A is a schematic diagram of a television network configured in accordance with an embodiment of the present invention.

FIG. 2 is a flow chart illustrating a first method embodiment of the present invention.

FIG. 3 is a slide showing an example issue question included in an online survey and example online survey response options and response tally in accordance with an embodiment of the present invention.

FIG. 4 is a schematic diagram illustrating the information components which may be used to determine an attitude value in accordance with an embodiment of the present invention.

FIG. 5 is a chart showing examples of general engagement actions and associated weights in accordance with an embodiment of the present invention.

FIG. 6 is a chart showing examples of general engagement levels and associated descriptions in accordance with an embodiment of the present invention.

FIG. 7 is a chart showing examples of political engagement levels and associated descriptions and values in accordance with an embodiment of the present invention.

FIG. 8 is a chart showing examples of groupings of advocacy engagement actions in accordance with an embodiment of the present invention.

FIG. 9 is a chart showing examples of advocacy engagement levels and associated descriptions and values in accordance with an embodiment of the present invention.

FIGS. 10A and 10B are flow charts illustrating a method of determining projection weights which may be used in accordance with a method embodiment of the present invention.

FIG. 11 includes a chart which illustrates the ranking of television shows based on a Net Support Score and QVI values.

FIG. 12 is a chart illustrating the relationship of Value Expressions, Value Orientations and Value Statements in accordance with an embodiment of the present invention.

FIG. 13 is a chart showing examples of Shopping Engagement levels and associated descriptions in accordance with an embodiment of the present invention.

FIG. 14 is a chart showing examples of Corporate Involvement levels and associated descriptions in accordance with an embodiment of the present invention.

### DETAILED DESCRIPTION OF EMBODIMENTS OF THE INVENTION

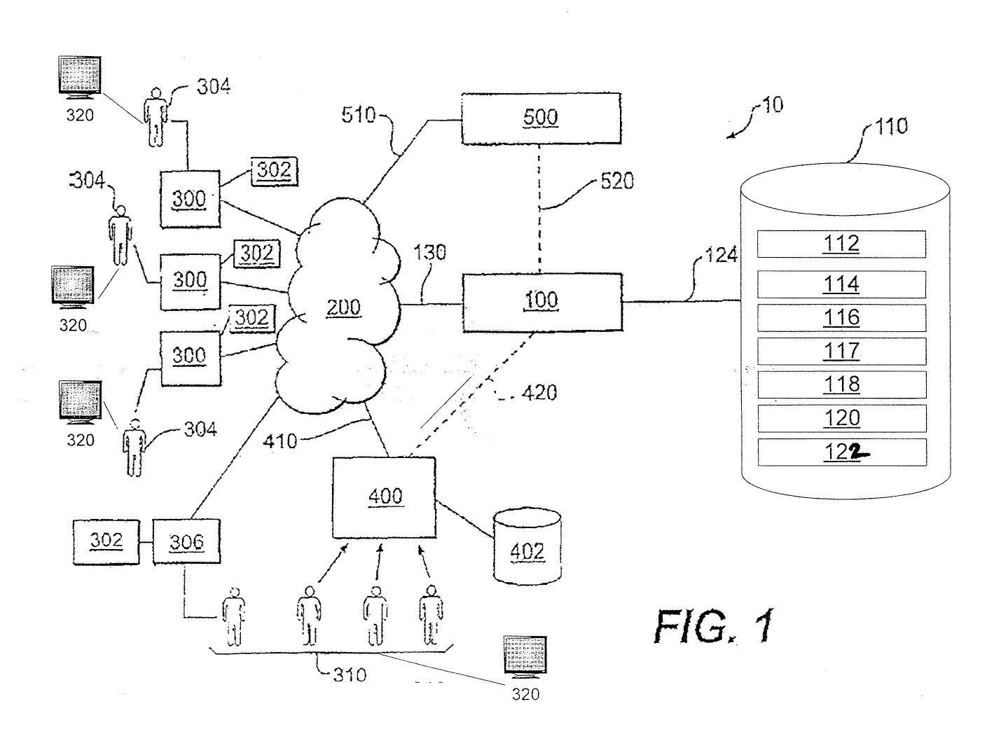

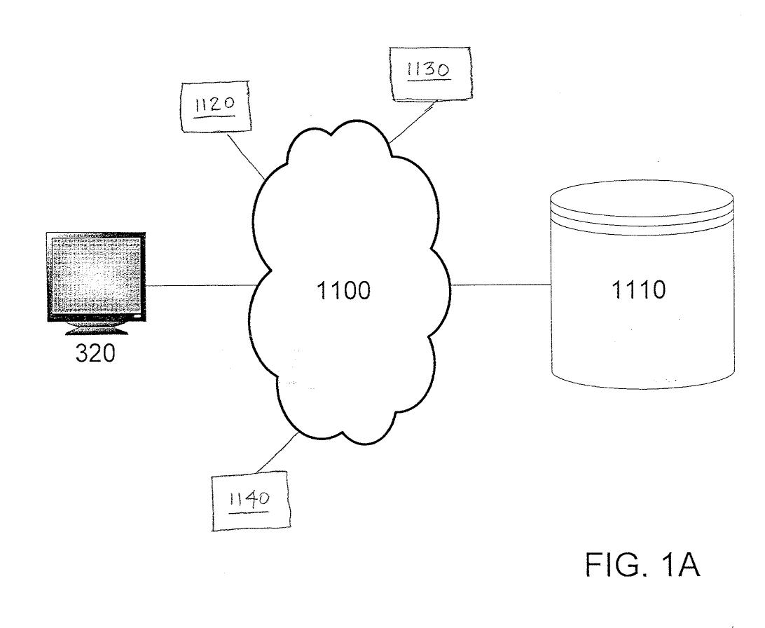

Reference will now be made in detail to a first embodiment of the present invention, an example of which is illustrated in the accompanying drawings. With reference to FIG. 1, the computer network 10 may include a computer 100 which may be a special use computer with permanent programming to accomplish the methods described herein, or a general use computer programmed with software to permit it to accomplish the methods described herein. The computer 100 may receive information from and store information in a central database 110 via a connection 124. The computer 100 may also be connected to a network 200 via a connection 130. The network 200 is preferably the Internet. The connections 124 and 130 may be any connection means that permit the transmission of electronic information.

The central database 110 may comprise one or more individual databases and/or database tables for storing information used by the computer 100. The information stored in the central database 110 may include survey response information 112, demographic information 114, website visitation information 116, and television viewing information 117, attitude value information 118, Quality Visitation Index (QVI) information, and net support score information 122 as well as any other information discussed herein which is capable of being stored in a database. The central database 110 may associate survey response information, demographic information, website visitation information, television viewing information, and attitude value information with an anonymous identifier for a participating audience member and/or participating audience member computer that the information relates to.

The network 200 may be connected to a plurality of participating audience member computers 300, which in turn are connected to displays 302, and which are associated with a plurality of participating audience members 304. The participating audience members 304 may use the computers 300 to access websites from one or more web servers 500 which form part of the world wide web and are connected via the Internet 200. “Participating” audience member computers 300 and “participating” audience members 304 are referred to as “participating” because each is used to participate in providing online survey response information to the computer 100. Visual and audible website content may be transmitted from the one or more web servers 500 and displayed by the participating audience member computers 300 on the displays 302 for viewing and listening by the participating audience members 304. Each of the participating audience members 304 may also be associated with one or more television displays or monitors 320. The participating audience members 304 may use the television monitors 320 to view the targeted content that may be delivered to them. The network 200 may also be connected to a plurality of non-participating audience member computers 306 which are associated with non-participating audience members 310. Each of the non-participating audience members 310 may also be associated with one or more television displays or monitors 320. The non-participating audience members 310 may use the television monitors 320 to view the targeted content that may be delivered to them.

As shown in FIG. 1A, the television monitors 320 may be connected via a wired or wireless connection to a communications network 1100. The communications network 1100 is intended to represent all networks that are necessary to provide content to the television monitor. Accordingly, it is appreciated that the communications network 1100 may constitute multiple networks, which may or may not be interconnected and which may use diverse communications protocols and network infrastructure. For example, and without limitation, the communications networks 1100 may include one or more cable, fiber optic, satellite, microwave, and wireless networks which are capable of delivering video, audio, digital, and/or other data between the devices connected to the network 1100.

As shown in FIG. 1A, the communications network 1100 may be connected to one or more third party databases 1110 which store one or more of: audience member profile information, television advertising content attributes, information for each television show, television program attributes, geographic data, audience member historical data, survey response information 112, demographic information 114, television viewing information 117, and attitude value information 118, as well as any other information discussed herein which is capable of being stored in a database. The information for each television show may include, but is not limited to, one or more of: a target group Reach Index, a minutes watched per viewer Index, information about the number of advertisements per hour, a past performance Index, a content quality index, program content information (action, comedy, nature, etc.), show type (documentary, news, sitcom, movie, etc.)

To the extent stored on the one or more third party databases 1110, the audience member profile information, television advertising content attributes, television program attributes, information for each television show, geographic data, and audience member historical data may be periodically retrieved by the computer 100 and stored in the central database 110. The computer 100 and the central database 110 may also provide the survey response information 112, demographic information 114, television channel viewing information 117, and attitude value information 118, to the one or more third party databases 1110 on a periodic basis.

The communications network 1100 may also be connected to one or more TV service providers 1120, which include without limitation, digital or analog broadcasters, digital video recorder (DVR) service providers, satellite TV service providers, cable TV operators (CO), and fiber optic TV service providers. The one or more TV service providers 1120, in turn, may be connected to one or more TV content providers 1130, such as, but not limited to, any one of the number of cable TV networks (CN) and satellite TV networks. The TV service providers 1120 may obtain TV content, including TV advertising content, from the TV content providers 1130 for delivery to participating audience members 304 and non-participating audience members 310. The TV content providers 1130 may also be connected to the communications network 1100. An alternative source of TV advertising content 1140, such as an advertising agency, may also be connected to the communications network 1100.

Online survey questions stored in the central database 110 may be transmitted from the computer 100 to the participating audience member computers 300. Participating audience members 304 may use their respective computers 300 to transmit online survey response information (i.e., answers to the online survey questions) over the Internet 200 to the computer 100. Television viewing information 117 for the participating audience members may also be transmitted for the participating audience members over the Internet 200 or other network to the computer 100. In an alternative embodiment, the online survey questions may be stored in one or more of the third party databases 402 associated with one or more third party computers 400. In such embodiment, the online survey questions may be sent from the third party computers 400 to the participating audience members 304. Thereafter, the survey response information may be sent from the participating audience member computers 300 to the computer 100 directly through the Internet, or alternatively through the one or more third party computers 400.

The computer 100 may also be connected to or otherwise receive information from one or more computers 400 and associated databases or database tables 402 maintained by one or more third party data providers. The third party data provider computers 400 and associated databases or database tables 402 may store demographic information and/or television viewing information relating to a plurality of non-participating audience members 310, and potentially relating to one or more of the plurality of participating audience members 304. The third party data provider computers 400 may receive non-participating audience member demographic information from non-participating audience member computers 306 and/or from other online and/or offline sources. The non-participating audience member demographic information may be transmitted from the third party computers 400 over an Internet connection 410 to the computer 100, or by an alternative means 420 such as a direct electrical signal connection or via electronic information storage media. Examples of third party data providers include, but are not limited to, the Nielsen Company, comScore, and Acxiom.

The computer 100 may be connected to or otherwise receive information from one or more web servers 500. The web servers 500 may transmit website content over connection 510 and the Internet 200 to the participating audience member computers 300 as well as computers 306 and displays associated with the non-participating audience members 310. Information may be transmitted between the computer 100 and the web servers 500 over the Internet 200, or by an alternative means 520 such as a direct electrical signal connection or via electronic information storage media.

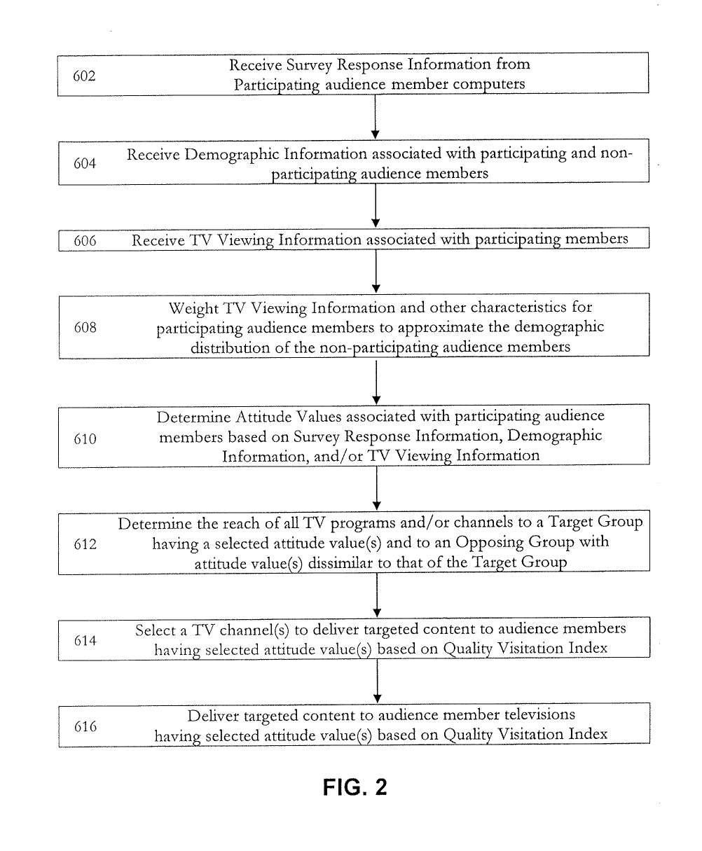

With reference to FIGS. 1 and 2, a method in accordance with an embodiment of the present invention may be carried out as follows. The method 600 may be used to select one or more television channels, and potentially in connection with one or more television programs, to display content on the television monitor 320 of the participating audience members 304 or the non-participating audience members 310. The content may be targeted for display as part of one or more television channel which are viewed by audience members 304 and 310 who are determined to likely have one or more particular attitudes represented by one or more attitude values. The television channel and potentially program, selected for display of content may be selected based on criteria that optimize the promotion of particular products, services and/or brands for audience members.

With reference to FIG. 2, in step 602 the participating audience members 304 may use the participating audience member computers 300 to provide online survey response information 112 to the computer 100. The online survey response information 112 may be provided as the result of a participating audience member 304 using the associated participating audience member computer 300 to request the online survey, or as a result of the computer 100, or alternatively some other computer, directing an unsolicited online survey to a participating audience member computer 300. The computer 100 may store the survey response information 112 in the central database 110, and associate the survey response information for a particular participating audience member 304 with an anonymous identifier for the particular participating audience member computer 300 and/or the particular participating audience member 304.

Preferably, but not necessarily, survey response information 112 may be collected from at least 1,000 participating audience member computers 300, more preferably from at least 3,000 participating audience member computers, and most preferably from 4,000 or more participating audience member computers. It is also preferable to receive survey response information 112 from the participating audience member computers 300 over the course of multiple survey “waves” separated in time. Preferably, the survey “waves” are received more than a day apart, more preferably more than 30 days apart, and most preferably about three or more months apart. It is also preferable for the participating audience members 304 to provide survey response information 112 in response to more than two survey waves. The survey questions in each of the survey waves may be the same or different.

The survey response information 112 may be used to determine the following categories of information: offline and online purchasing information, including but not limited to Brand Attribute information; Value Orientation information; Purchase Category information indicating relative Value Orientations for different purchase categories; Purchase Orientation information indicating the relative importance of price, convenience and brand for purchases; Purchase Engagement information indicating the manner research of potential purchases is conducted; Shopping Engagement information; Corporate Involvement information; Issue Question information; Political Orientation information; Voting History information; Party Affiliation information; Level of Engagement information.

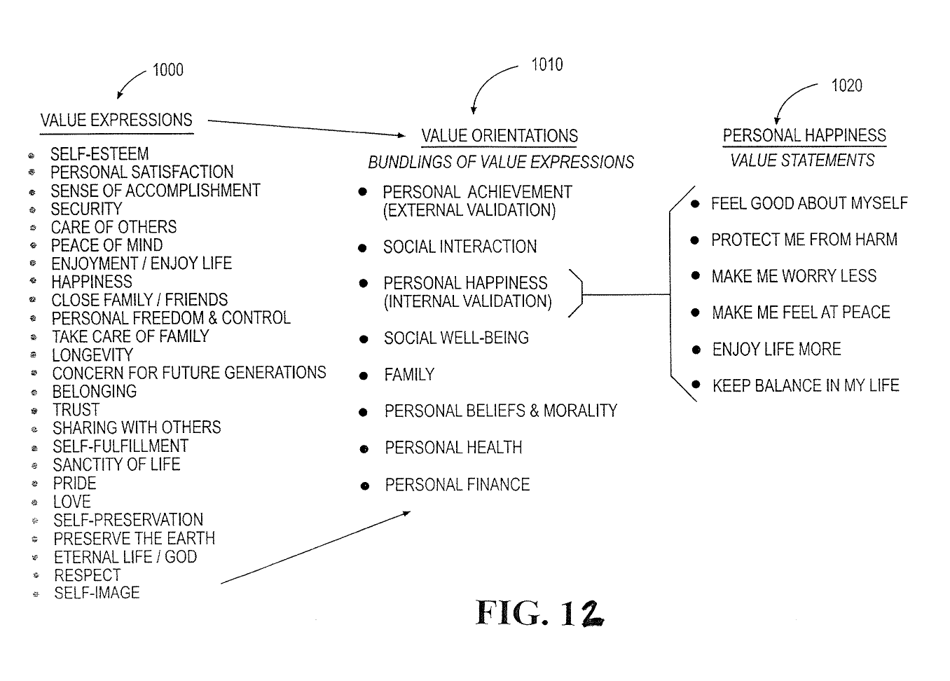

With reference to FIGS. 1 and 12, Value Orientation information may be determined by the input of answers (survey response information) to a set of questions at an audience member computer 300. The survey response information may be sent from the audience member computer 300 to the central computer 100 and may be stored in the central database 110. The computer 100 may run a statistical analysis of the survey response information to determine a numeric score, for example in the range of 1-5, for each of a number of Value Expressions 1000. The numeric score may indicate the importance of each Value Expression to an audience member.

The computer 100 may compare the Value Expression 1000 scores for the audience member with Value Expression score requirements associated with a number of Value Orientation Group 1010 definitions. The computer 100 may thus determine if the Value Expression scores qualify the audience member computer 300 to have a low, medium or high affinity to one or more Value Orientation Groups 1010 based on this comparison. This affinity may comprise the Value Orientation information. The computer 100 may store information in the database 110 that indicates the affinity of the audience member computer 300 with each Value Orientation Group 1010. The Value Orientation Groups 1010 may have Value Statements 1020 associated with each of them. The Value Orientation Groups 1010 may be used to determine characteristics of groups of audience member computers.

Purchase Category information may also be determined from the survey information. Purchase Category Groups may indicate Value Orientations for audience members for particular product or service types, such as food, clothing, home, etc. The computer 100 may compare the Value Expression scores for the audience member computer 300 with Value Expression score requirements associated with a number of Purchase Category Group definitions. The computer 100 may determine if the Value Expression scores qualify the audience member computer 300 to have a low, medium or high affinity to one or more Purchase Category Groups based on this comparison. This affinity level may comprise the Purchase Category information. The computer 100 may store information that indicates the affinity of the audience member computer 300 with each Purchase Category Group.

For example, there may be 15 Purchase Category Groups which indicate an audience member computer 300 affinity with Value Orientations and Brand Attribute information as they pertain to fresh foods, packaged or processed foods, quick service restaurants, household goods, pet supplies, health and beauty products, children's products, home furnishings, automobiles, applare and accessories, electronics and computers, sports products, telecommunication services, and financial services. The use of Purchase Category Groups may be used instead of Value Orientation Groups, as explained further below.

The survey response information may also be used to determine Purchase Orientation information for an audience member computer 300 which indicates the relative importance of price, convenience (or accessibility), and brand for particular purchases. The relative importance of price, convenience and brand may be indicated by a numeric score or ranking and may be applied broadly across all purchases or applied to groups of purchases, such as those that comprise the Purchase Category Groups, for example. The Purchase Orientation information may be stored by the computer 100 in the central database 110.

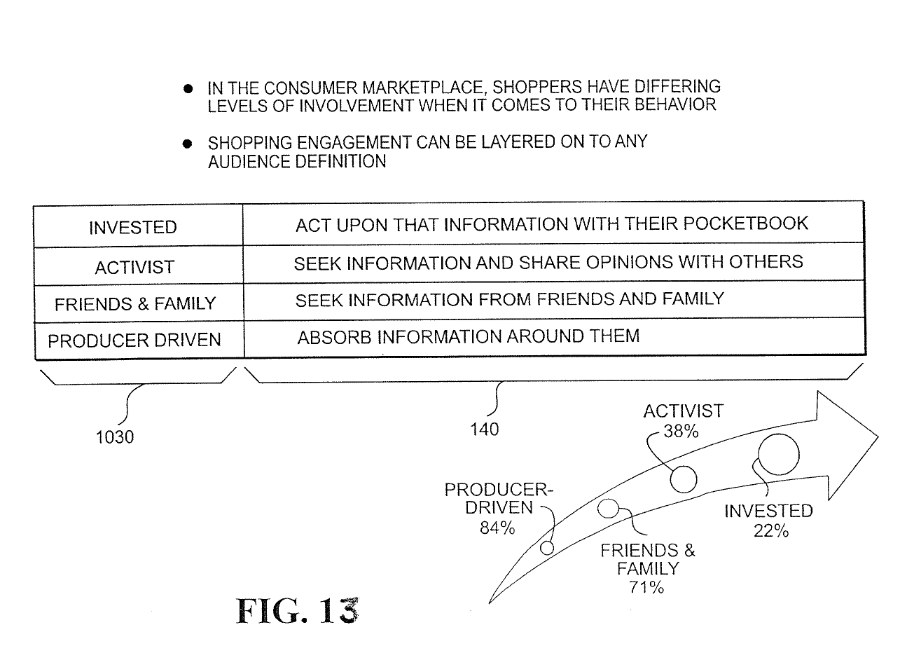

With reference to FIGS. 1 and 13, the survey response information 112 may also be used to determine Shopping Engagement information in the form of the affinity of an audience member computer 300 with one or more Shopping Engagement Groups 1030 for purchases overall or categories of purchases. The Shopping Engagement Groups 1030 may each be associated with shopping characteristics 1040. The level of shopping engagement may be determined by the computer 100 for each audience member computer 300, which in turn may be used to determine the level of shopping engagement for any audience member definition or group. The level of shopping engagement may comprise the Shopping Engagement information which may be stored by the computer 100 in the central database 110. For example, the percentage of women aged 35-45 that fall into each of the four Shopping Engagement Groups 1030 shown in FIG. 13 may be determined by the computer 100.

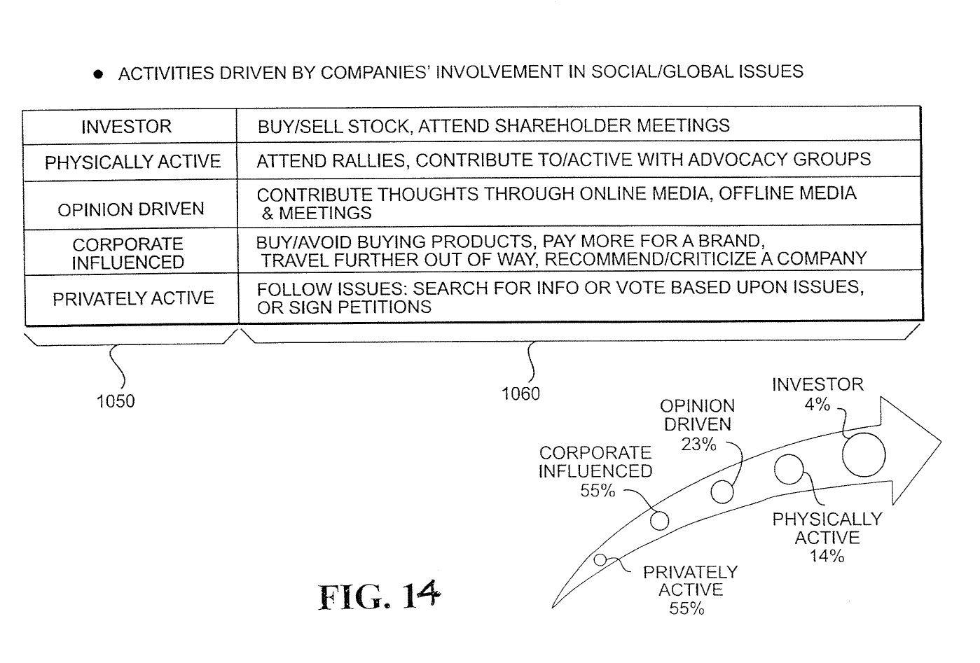

With reference to FIGS. 1 and 14, the survey response information 112 may also be used to determine Corporate Involvement information in the form of the affinity of an audience member computer 300 with one or more Corporate Involvement Groups 1050, which may each be associated with corporate involvement characteristics 1060. The level of corporate involvement may be determined by the computer 100 for each audience member computer 300 and for audience member groups or definitions. This Corporate Involvement information may be stored by the computer 100 in the central database 110.

The survey response information 112 may also be used to determine Brand Attribute information in the form of the affinity of an audience member computer 300 with one or more brand characteristics and associated ratings, such as quality (e.g., high v. low), performance (e.g., best, good, poor), aesthetic impression (e.g., pleasing v. unpleasing), functionality (e.g., most v. least), innovativeness (e.g., most v. least), value (e.g., high v. low), luxuriousness (e.g., most v. least), easy of use (e.g., best v. worst), uniqueness (e.g., most v. least), and/or prestige (e.g., more v. less). Brand Attribute groups of audience members may be determined and associated with one or more Brand Attribute characteristics and associated ratings by the computer 100. The Brand Attribute information and Brand Attribute groups may be stored by the computer 100 in the central database 110.

The survey response information 112 may also include demographic information associated with the participating audience members 304. The participating audience member demographic information which is part of the survey response information 112 may include the following types of information: age, income, gender, census region, race, sexual orientation, education level, religious affiliation, frequency of attendance at religious services, union participation, frequency of Internet use information, hobbies, interests, personality traits and the like. It is appreciated that the foregoing list of demographic information is non-limiting and that embodiments of the present invention may utilize any types of demographic information that relates to audience members.

With renewed reference to FIG. 2, in step 604 demographic information 114 (other than that which may be included in the survey response information 112) may be received by the computer 100 for participating and/or non-participating audience members. The demographic information 114 may be collected for the non-participating audience members 310 and the participating audience members 304 by the one or more third parties, or derived from other sources of online and/or offline information. The third parties may collect or derive the demographic information 114 in any known manner, including, but not limited to tracking the online behavior of the non-participating audience members 310 and/or participating audience members 304. It is appreciated that the demographic information 114 which is associated with non-participating audience members 310 and/or associated with the participating audience members 304 may be collected by the host of the computer 100 instead of by one or more third parties in an alternative embodiment of the present invention.

The demographic information 114 pertaining to a particular participating audience member may be associated with the anonymous identifier for the participating audience member 304 in the central database 110 by the computer 100. Similarly, demographic information 114 pertaining to a particular non-participating audience member may be associated with an anonymous identifier for the non-participating audience member 310 in the central database 110 by the computer 100. Further, the demographic information 114 may be provided multiple times, preferably at least once per wave, and more preferably at least once per month.

The demographic information 114, as it pertains to participating audience members 304, may be stored in the central database 110 so as to be associated with the same anonymous identifier used in connection with the survey response information 112. The demographic information 114, as it pertains to non-participating audience members 310, may not be specific to individual non-participating audience members, but instead descriptive of a large group of online audience members. For example, the demographic information 114 as it pertains to non-participating audience members 310 may be collected for a number of audience members in a common geographic area, such as the United States, or a number of audience members in any other group which may be characterized as having some common affiliation, such as political, income, ethnic, racial, religious, age, gender, or the like. More specifically, in a preferred embodiment of the present invention, the demographic information 114 pertaining to non-participating audience members 310 may be received or stored such that it pertains to individual non-participating audience members defined by age ranges, gender, household income ranges, census regions, and intensity of Internet use (Heavy/medium/light), etc.

With continued reference to FIGS. 1 and 2, in step 606, television viewing information 117 pertaining to the participating audience members 304, and potentially pertaining to the non-participating audience members 310, may be received by the computer 100. The television viewing information 117 may be collected for the participating audience members 304 and the non-participating audience members 310 directly by the computer 100, or alternatively from the one or more third party computers or television set-top boxes 400 and/or associated databases 402. It is appreciated, however, that embodiments of the present invention may be practiced without receiving television viewing information 117 pertaining to the non-participating audience members 310.

While it is preferable to track such television viewing information for all participating audience members 304 over a period of one to three months or more (i.e., a wave), it is appreciated that, without departing from the intended scope of the present invention, some participating audience members may “drop out” of the tracking process and therefore television viewing information for such participating audience members may only be available over the course of more than one session, day, or week, as opposed to one to three months.

The television viewing information 117 may be received by the central database 110 from the computer 100 and stored therein. The tracking of the television viewing information 117 may be implemented by using software installed on participating and non-participating audience member televisions or set-top boxes, or any other manner of tracking the television viewing behavior of an audience member.

The television program visitation information 117 may include, but is not necessarily limited to, program watched, number of minutes watched, channel watched, date, time of day, and the like. A session is defined by a period of time when a person watches one or more television programs.

In step 608 of FIG. 2, weight factors may be determined for participating audience members based on a comparison by computer 100 of the demographic information 114 for participating audience members 304 with the demographic information for non-participating audience members 310. The weight factors may be used to weight the television program visitation information 117 and other characteristics pertaining to the participating audience members 304 so that the population of participating audience members in terms of demographic groupings by age, gender, etc., projects more closely to the demographic distribution of the overall television viewing population in terms of the same demographic groups in the same time period.

In step 610 of FIG. 2, attitude values associated with the participating audience members 304 may be determined based on the survey response information 112, the demographic information 114 and/or the television viewing information 117. The attitude values may indicate the participating audience member's political attitude, legislative attitude, regulatory attitude, corporate attitude, and/or product attitude. In some embodiments of the invention, the attitude values may comprise entirely or be based in part on one or more of the following types of information: Brand Attribute information, Value Orientation information, Purchase Category information, Purchase Orientation information, Purchase Engagement information, Shopping Engagement information, and Corporate Involvement information.

In step 612, the reach of each television program or channel to a target group of participating audience members having a selected attitude value or values, and the reach of all television program or channel to an opposing group of participating audience members having an attitude value or values dissimilar to the selected attitude values of the target group may be determined. The determined reach may indicate the number of participating audience members in the target group and in the opposing group that watch each television program.

In step 614 of FIG. 2, one or more television channels may be selected to include content which is targeted to the target group and which is not targeted to the opposing group based on a comparison of the reach of the television program to the target group with the reach of the television program to the opposing group. In one example, it may be preferred to select a television program or channel for delivery of targeted content which has the largest differential in terms of reach between the target group and the opposing group.

In step 616 of FIG. 2, the targeted content may be displayed by the participating and non-participating audience member television monitors 320 as a result of the participating 304 and non-participating audience member 310 viewing the television channel selected in step 614.

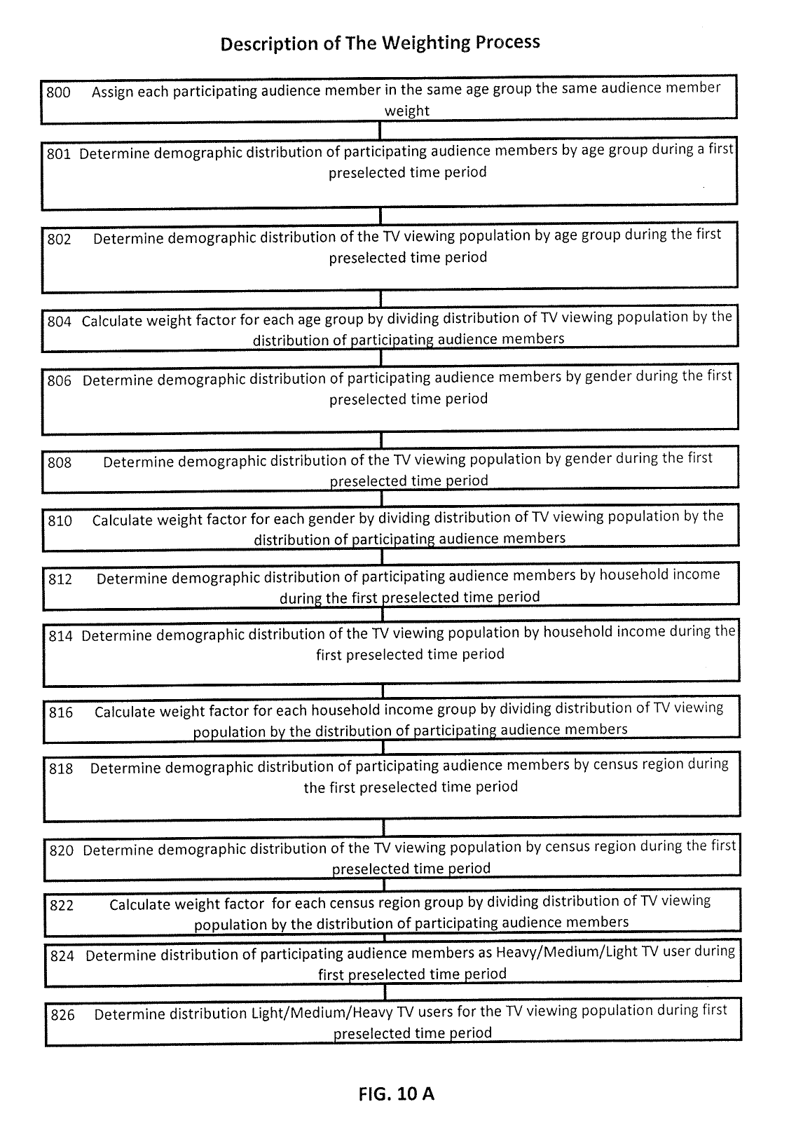

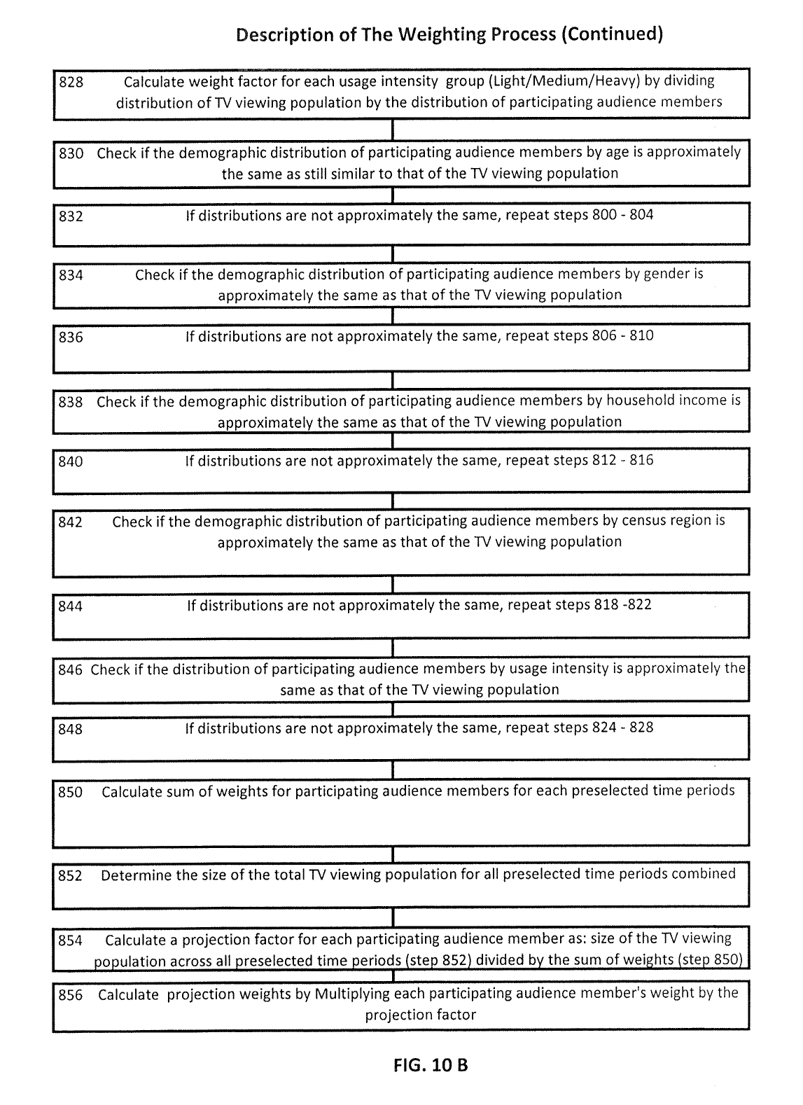

The weight factors referenced in connection with step 608 of FIG. 2 may be determined using the method illustrated in FIGS. 10A and 10B. With reference to FIGS. 10A and 10B, in step 800, each participating audience member in a selected analysis period and in the same demographic group (e.g., age group) may be assigned an equal initial weight value. The analysis period may be any period of time over which television viewing information is available for the participating audience members 304. Preferably the analysis period will be more than one month, and more preferably at least about 3 months. The method illustrated in FIGS. 10A and 10B is preferably carried out for each month's worth of information in the analysis period.

In step 801 of FIG. 10A, the demographic distribution by percentage of the participating audience members 304 in terms of age group may be determined by the computer 100 from the demographic information 114. Examples of age groups in years are 18-24, 25-34, 35-44, 45-54, 55-64, and 65 and over. It is appreciated that other age groups could be used without departing from the intended scope of the present invention. In step 802, the demographic distribution by percentage in terms of age group of the television viewing population for a geographic region such as the United States may be determined by the computer 100 from the demographic information 114. The television viewing population is comprised almost entirely, if not entirely, of the non-participating audience members 310, but may include to some small degree the participating audience members 304 as well. In step 804, an age weight factor may be calculated using the computer 100 by dividing the demographic distribution of the television viewing population in terms of age group by the demographic distribution of the participating audience members 304 in terms of a corresponding age group. For example, for the age group 18-24, an age weight factor may be calculated by dividing the demographic distribution by percentage of the television viewing population in the 18-24 year old range by the demographic distribution by percentage of the participating audience members 304 in the same age range. The age weight factor may be stored by the computer 100 in the central database 110.

In step 806 of FIG. 10A, the demographic distribution by percentage of the participating audience members 304 in terms of gender group may be determined by the computer 100 from the demographic information 114. Examples of gender groups are male and female. In step 808, the demographic distribution by percentage in terms of gender group of the television viewing population may be determined by the computer 100 from the demographic information 114. In step 810, a gender weight factor may be calculated using the computer 100 by dividing the demographic distribution in terms of gender of the television viewing population by the demographic distribution of the participating audience members 304 in terms of a corresponding gender group. The gender weight factor may be stored by the computer 100 in the central database 110.

In step 812 of FIG. 10A, the demographic distribution by percentage of the participating audience members 304 in terms of household income group may be determined by the computer 100 from the demographic information 114. Examples of household income groups are: under $25,000, $25,001-$50,000, $50,001-$75,000, etc. In step 814, the demographic distribution by percentage in terms of household income group of the television viewing population may be determined by the computer 100 from the demographic information 114. In step 816, a household income weight factor may be calculated using the computer 100 by dividing the demographic distribution in terms of household income of the television viewing population by the demographic distribution of the participating audience members 304 in terms of a corresponding household income group. The household income weight factor may be stored by the computer 100 in the central database 110.

In step 818 of FIG. 10A, the demographic distribution by percentage of the participating audience members 304 in terms of census region may be determined by the computer 100 from the demographic information 114. In step 820, the demographic distribution by percentage in terms of census region of the television viewing population may be determined by the computer 100 from the demographic information 114. In step 822, a census region weight factor may be calculated using the computer 100 by dividing the demographic distribution in terms of census region of the television viewing population by the demographic distribution of the participating audience members 304 in terms of a corresponding census region. The census region weight factor may be stored by the computer 100 in the central database 110.

In step 824 of FIG. 10A, the demographic distribution by percentage of the participating audience members 304 in terms of television use during a period of time (Heavy/medium/light) may be determined by the computer 100 from the demographic information 114. Examples of television use groupings are: Heavy—more than 3430 minutes per month; light—less than 300 minutes per month; and medium—everyone else. In step 826, the demographic distribution by percentage in terms of television use of the television viewing population may be determined by the computer 100 from the demographic information 114. In step 828 of FIG. 10B, a television use weight factor may be calculated using the computer 100 by dividing the demographic distribution in terms of television use of the television viewing population by the demographic distribution of the participating audience members 304 in terms of a corresponding television use grouping. The television use weight factor may be stored by the computer 100 in the central database 110.

In steps 830-848 of FIG. 10B, each of the subroutines pertaining to determination of the age group, gender group, household income group, census region, and television use groupings set forth in steps 801-828 may be repeated until the multiplication of the determined weight factor by the corresponding demographic distribution by percentage of the participating audience members 304 results in a product that is approximately the same as the demographic distribution by percentage of the television population of the same demographic metric. For example, steps 830-848 are repeated iteratively until the multiplication of the age group weight factor by the demographic distribution by percentage in terms of age of the participating audience members 304 results in a product that is approximately the same as the demographic distribution by percentage of the television viewing population in terms of age. The process is further iterated until the resulting demographic distributions on a demographic category-by-category basis are also approximately the same for each demographic category such as gender, household income, census region, and television use. Values are considered to be “approximately the same” in the foregoing steps when continued iteration of the process does not result in any substantial change to the values from one iteration to the next. It should also be appreciated that the selection of the demographic information 114 used in the foregoing example is considered to be non-limiting of the present invention. Fewer, more, and/or different demographic information 114 may be used in steps 801-848 without departing from the intended scope of the invention.

Steps 800-848 are repeated for each of a number of individual time periods which may make up the analysis period. Preferably, steps 800-848 are repeated for each month of data that is available for the participating audience members 304. For example, if the analysis period is a three month period, steps 800-848 may be carried out three times to generate three sets of weight factors corresponding each individual month's demographic distributions.

In step 850 of FIG. 10B, for each participating audience member 304 for each preselected time period, the computer 100 may sum the weight factors determined in steps 801-848 across each time period (e.g., month) in the analysis period and across all weight factors as they apply to each particular participating audience member. The resulting sum may be stored in the central database 110 in association with the anonymous identifier for the participating audience member. For example, for a 20 year old, male participating audience member who earns $45,000 per year, lives in the Northeast U.S., and watches television 500 minutes per month, the computer 100 may sum the 18-24 year old group, male gender group, $25,001-$50,000 household income group, Northeast U.S. census region, and medium television use weight factors calculated for each of three months of demographic information, and store such sum in association with the anonymous identifier for the participating audience member in the central database 110.

In step 852, the size of the total television viewing population for the analysis period may be determined by the computer 100 from the demographic information 114. For example, if the television viewing population was 160 million individuals in month one, 170 million individuals in month two, and 180 million individuals in month three of the analysis period, the total television viewing population for the analysis period would be 510 million viewers.

In step 854, the computer 100 may calculate a projection factor for each participating audience member 304, which is the quotient of the size of the television viewing population determined in step 852 divided by the sum of the weights calculated in step 850. In step 856, a projection weight for each participating audience member 304 may be calculated using the computer 100 by multiplying the weight assigned to the particular participating audience member in step 800 by the projection factor calculated in step 854.

The projection factors for the participating audience members 304 which were determined as a result of carrying out the process set forth in FIGS. 10A-10B may be utilized to determine a Quality Visitation Index (QVI) value, which in turn is used to determine which television channel(s) and/or programs may be selected to deliver targeted content to the participating and non-participating audience members. With reference to QVI determination, in a first step 900 an analysis period is selected which should preferably be the same analysis period used in connection with the process set forth in FIGS. 10A-10B.

In step 902, the projection factors for the participating audience members 304 may by applied by the computer 100 to the television viewing information and other characteristics associated with the participating audience members to produce projected television viewing information and projected characteristic information. “Projected” information, essentially scales up or down the information related to an individual participating audience member so that the information relating to a particular participating audience member is proportional to the make up of the demographic groups (by age, gender, etc.) that the participating audience member is a part of. For example, the projection factor for a particular participating audience member 304 may be multiplied by the following television viewing information 117 that pertains to the same participating audience member for the analysis period: number of visits to television channels; number of minutes spent on television channels; number of sessions; and television program viewership duration.

In step 904, the computer 100 may determine the projected monthly viewership metrics for each television channel viewed by one or more participating audience members for each month in the analysis period using the television viewing information 117. The viewership metrics determined for each television channel or program may include, but are not necessarily limited to: the number of unique viewers; the amount of time (e.g., number of minutes) spent watching the program; number of advertisements per television program; and number of advertisements per hour. The determination of the viewership metrics for a television channel may be influenced by the projection factors referenced above. For example, if a single participating audience member 304 has a projection factor of “2”, and the participating audience member spent 10 minutes watching a television channel, it may be counted as spending 20 minutes watching the television channel due to the projection factor.

In step 906, the projected viewership metrics determined in step 904 may be combined (i.e., summed) by the computer 100. Discount factors may be applied to the monthly viewership metrics before combining them to account for the decreased value of viewership metrics that pertain to an earlier month. For example, if the analysis period consists of the preceding three months of viewership metrics, the viewership metrics for the first month in the analysis period may be multiplied by a discount factor of 0.5, and the viewership metrics for the second month may be multiplied by a discount factor of 0.75. The foregoing examples of discount factors are illustrative only, and not considered limiting to the intended scope of the present invention. The combined monthly viewership metrics may be stored in the central database 110 by the computer 100.

In step 908, the overall reach of each television channel watched by one or more participating audience members 304 may be calculated by the computer 100 using the television program viewership information 117. The overall reach may be the quotient of the number of projected participating audience member unique visits to the television channel divided by the total number of projected participating audience members for the analysis period. The overall reach of each television channel may be stored by the computer 100 in the central database 110.

In step 910, the computer 100 may determine the projected number of minutes spent watching each television channel per projected participating audience member viewer (min/Viewer) using the television program viewership information 117. The (min/Viewer) for each television channel may be stored by the computer 100 in the central database 110.

In step 912, the computer 100 may determine which of the participating audience members qualify as being in the target group of participating audience members to which the targeted content is to be directed. The target group of participating audience members may be determined by using the computer 100 to determine one or more attitude values for each of the participating audience members. The determined attitude values for the participating audience members may then be compared by the computer 100 with a selected attitude value threshold and/or an attitude value range. If the attitude value for a particular participating audience member satisfies the selected attitude value threshold and/or range, then the participating audience member may be indicated to be part of the target group by the computer 100.

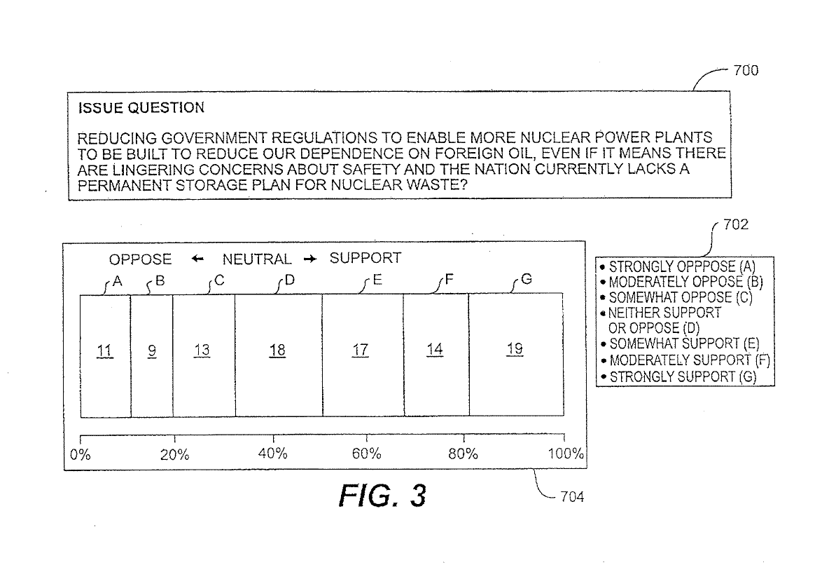

The survey response information 112 may be used to determine an attitude value for a participating audience member 304 either directly or indirectly. For example, with reference to FIG. 3, the survey response information 112 may include the responses of the participating audience members 304 to an issue question 700 concerning government regulation of nuclear power plants. The participating audience members 304 may use the participating audience member computers 300 to indicate their attitude about such regulation by selecting one of the attitudes provided in the menu 702 which range from “strongly oppose” to “strongly support.” The survey response information 112 for a particular issue may result in a tally 704 which is graphically represented in FIG. 3 to indicate the percentage number of participating audience members 304 who characterized themselves as having each of the corresponding attitudes. The survey response information 112 of each participating audience member 304 relating to each issue question 700 may be stored in the central database 110.

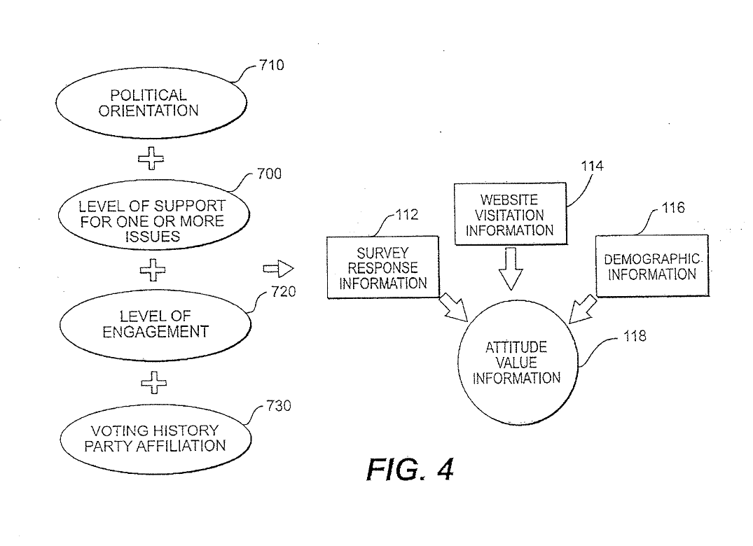

With additional reference to FIG. 4, in addition to answers to the issue questions 700, the survey response information 112 may further include answers to political orientation questions 710, level of engagement questions 720, and voting history/party affiliation questions 730, for example. Political orientation questions 710 are more general in character than issue questions 700. An example of an issue question is provided in FIG. 3, as compared with the following examples of political orientation questions 710:
Are you opposed to government regulation of business?
Are you opposed to government provided healthcare?
   Examples of voting history/party affiliation questions 730 may include:
How often do you vote?
What elections do you normally participate in as a voter?
What political party or parties are you a member of?
   The foregoing examples of issue questions 700, political orientation questions 710 and voting history/party affiliation questions 730 are intended to be illustrative and non-limiting of the intended scope of the present invention. It is appreciated that one or more of these types of questions (i.e., issue, political orientation, and voting history/party affiliation) may not be included in the survey response information 112 without departing from the intended scope of the present invention.

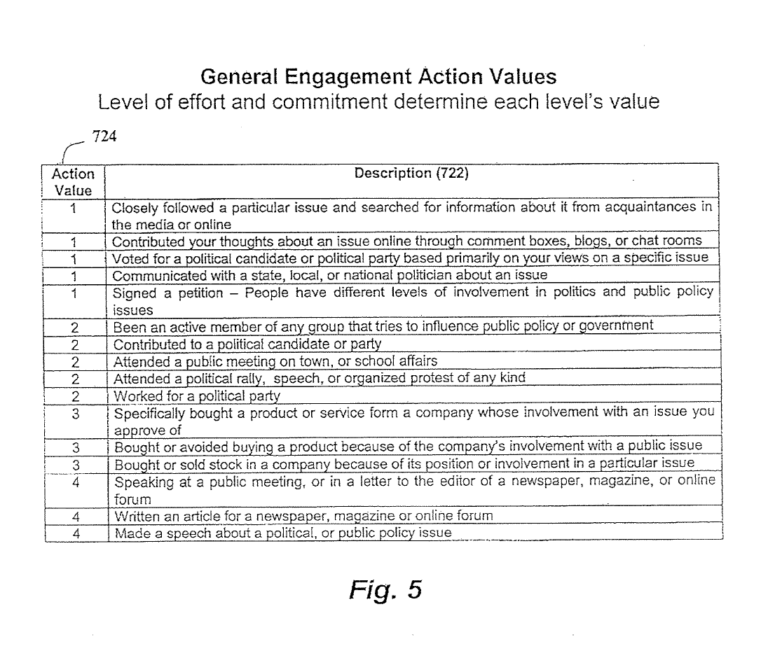

Additionally, level of engagement questions 720 which may be included in the survey response information 112 may be used to determine one or more level of engagement values for each participating audience member 304 on one or more engagement scales illustrated by FIGS. 5-9. The three engagement scales illustrated in FIGS. 5-9 are a general engagement scale, a political engagement scale, and an advocacy engagement scale. The number and type of engagement scales, as well as the associated definitions, levels and values used in connection with the scales are considered to be illustrative only and non-limiting of the invention which may be carried out without any engagement scales whatsoever. Alternative level of engagement scales are illustrated in FIGS. 15-16, for example.

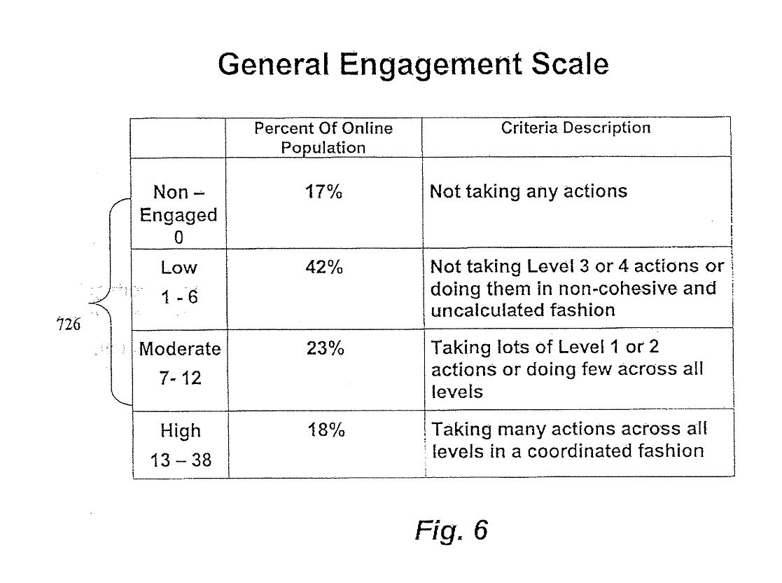

With additional reference to FIG. 5, the survey response information 112 may indicate that a particular participating audience member 304 has taken one or more of the general engagement actions 722 listed in FIG. 5. Each of the illustrative general engagement actions 722 may be associated with an action value shown in the left column of chart 724 by the computer 100. The computer 100 may compare the survey response information 112 for each participating audience member 304 with the actions 722 to determine the general engagement levels in the chart 726 shown in FIG. 6 that should be attributed to the participating audience member. The action values that the survey response information 112 indicates should be attributed to a participating audience member 304 may be added together by the computer 100 to aggregate a cumulative general engagement value. With reference to FIG. 6, each of four illustrative general engagement value ranges 726 are illustrated, ranging from “non-engaged” which is associated with a cumulative general engagement value of 0 to a “high” level of engagement associated with a cumulative general engagement value in the range of 13-38. The cumulative general engagement value for each participating audience member 304 may be stored by the computer 100 in the central database 110 in association with the anonymous identifier for the participating audience member.

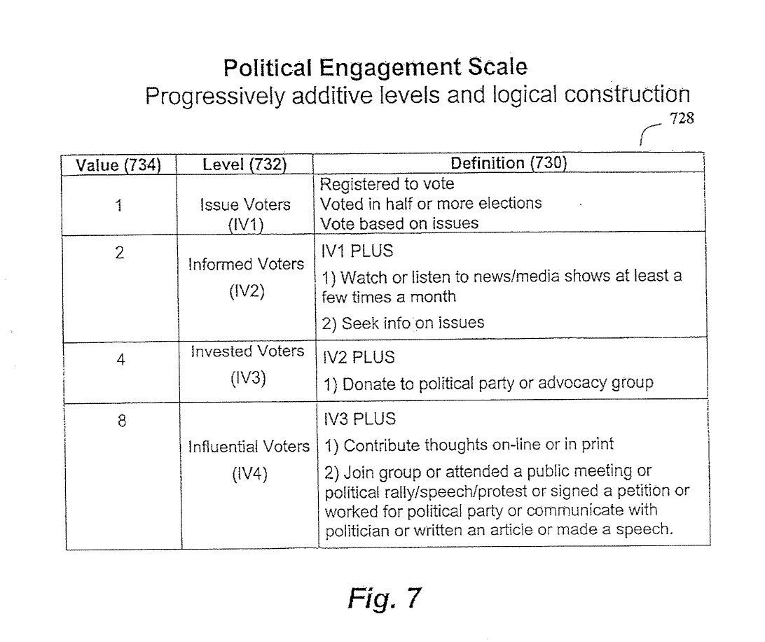

With reference to FIG. 7, the survey response information 112 may further indicate that a particular participating audience member 304 satisfies one or more of the political engagement definitions 730 shown in chart 728. Based on a comparison of the survey response information 112 with the definitions 730 by the computer 100, the participating audience member 304 may be associated with one of the political engagement levels 732 and associated political engagement values 734 on the illustrative political engagement scale. As indicated in the chart 728, the political engagement levels 732 and associated values 734 may be hierarchal such that a participating audience member 304 must satisfy the requirements of the preceding lower level in order to be eligible to satisfy the definition 730 of the next higher level. The political engagement value 734 for each participating audience member 304 may be associated with the anonymous identifier for the participating audience member by the computer 100 in the central database 110.

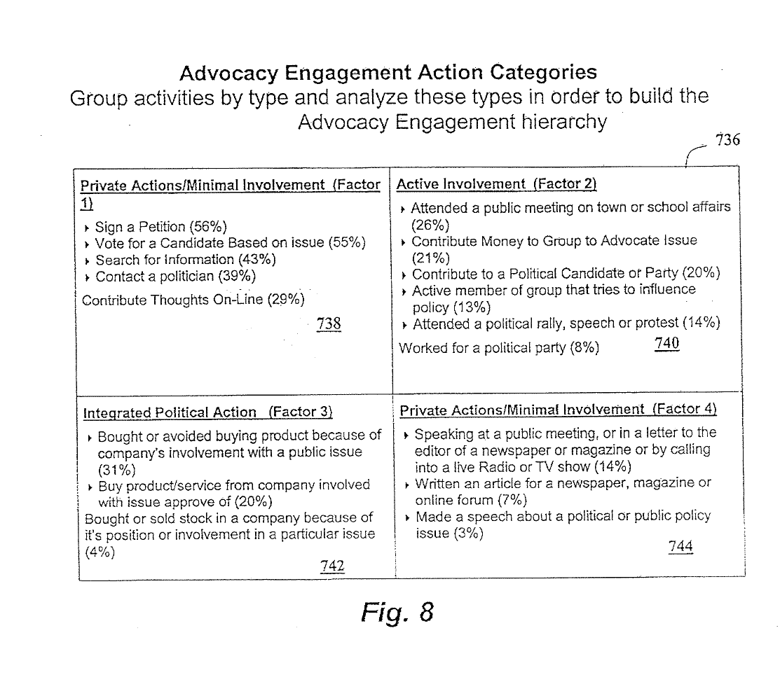

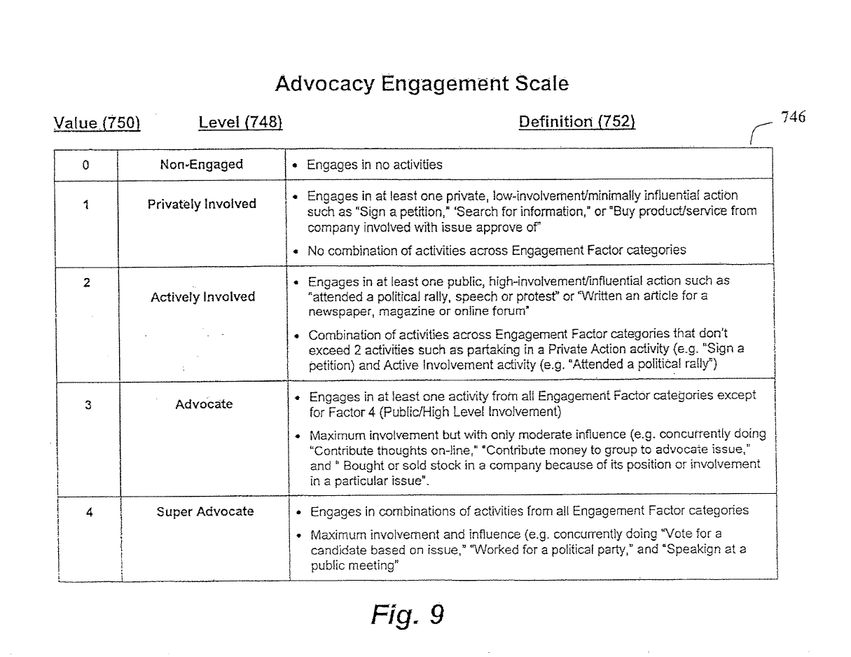

With reference to FIG. 8, the survey response information 112 may further indicate that a particular participating audience member 304 has taken one or more of the advocacy engagement actions shown in the chart 736. In the illustrative example shown, each advocacy engagement action may be placed in one of four groups: private actions 738, active involvement actions 740, integrated political actions 742, and public/high level involvement actions 744. With reference to FIGS. 8 and 9, a particular participating audience member 304 may be associated with one of the advocacy engagement levels 748 and corresponding advocacy engagement values 750 shown in the chart 746 based on a comparison implemented by the computer 100 between (i) the advocacy engagement actions indicated in the participating audience member's survey response information 112 and (ii) the advocacy engagement level descriptions 752. The advocacy engagement value 750 corresponding to the advocacy engagement level 748 that the participating audience member 304 qualifies for may be associated by the computer 100 with the anonymous identifier for the participating audience member in the central database 110.

With renewed reference to FIGS. 6-9, one or more of the cumulative general engagement values 726, the political engagement values 734, and the advocacy engagement values 750 may be used in the determination of the attitude value 118 for each participating audience member. Determination of the attitude value 118 may be further based on television viewing information 117 and/or demographic information 114. Preferably, the attitude value information 118 is determined from the combination of survey response information 112, the television viewing information 117, and the demographic information 114 associated with the particular participating audience member 304.

With reference to FIGS. 12-14, in an alternative embodiment of the present invention, an attitude value may also be determined based in whole or in part on one or more of Value Orientation information, Purchase Category information, Purchase Orientation information, Brand Attribute information, Purchase Engagement information, Shopping Engagement information, Corporate Involvement information, Issue Question information, Political Orientation information, Voting History information, Party Affiliation information, and Level of Engagement information, which are described above.

In step 914, the computer 100 may determine the projected monthly viewership metrics for each television program viewed by the participating audience members 304 in the target group for each month in the analysis period using the television viewing information 117. The viewership metrics determined for each television channel may include the same metrics as referenced in connection with step 904, and may be influenced by the projection factors in the same manner as in step 904.

In step 916, the projected monthly viewership metrics determined in step 914 may be combined (i.e., summed) by the computer 100 in the same manner as set forth in connection with step 906. Discount factors may be applied to the monthly viewership metrics before combining them to account for the decreased value of viewership metrics that pertain to an earlier month. The combined projected monthly viewership metrics may be stored in the central database 110 by the computer 100.

In step 918, the target group reach of each television channel watched by the participating audience members 304 in the target group may be calculated by the computer 100 using the television viewing information 117. The target group reach may be the quotient of the number of projected unique visitors to the television channel by audience members in the target group divided by the total number of projected participating audience members in the target group for the analysis period. The target group reach of each television channel may be stored by the computer 100 in the central database 110.

In step 920, the computer 100 may determine the number of minutes spent viewing each program per projected participating audience member in the target group (target group min/viewer) using the television viewing information 117. The target group min/viewer may be determined by totaling the number of minutes spent viewing a program or channel by all of the projected participating audience members associated with the target group divided by the number of participating audience member unique viewers who are in the target group.

In step 922, the computer 100 may determine the number of participating audience members 304 in the target group that were unique viewers of each television channel using the television viewing information 117. The number of participating audience members 304 in the target group who were viewers for each channel may then be compared with a threshold number of viewers that is required for the channel to be further considered for delivery of targeted content. The computer 100 may store an indication in the central database 110 of which television channels are and/or are not to be considered further for the delivery of targeted content based on the outcome of this step.

In step 924, the computer 100 may calculate a target group Reach Index for each television program or channel still under consideration for use in the delivery of targeted content. The target group Reach Index may be the quotient of the target group reach for each program or channel determined in step 918 divided by the overall reach of each program or channel determined in step 908. The target group Reach Index may be stored by the computer 100 in the central database 110.

In step 926, the computer 100 may calculate a minutes per program or channel Index for each channel or program still under consideration. The minutes per program or channel Index may be the quotient of the number of minutes spent viewing each channel or program per projected participating audience member unique viewer in the target group determined in step 920 divided by the number of minutes spent viewing each channel or program per projected participating audience member unique viewer determined in step 910. The minutes per unique visitor index may be restrained to a predefined range, 0.7 to 1.3 in a preferred embodiment. The target group min/Viewer for each channel or program may be stored by the computer 100 in the central database 110. The minutes per unique viewer Index may be stored by the computer 100 in the central database 110.

In step 932, the computer 100 may calculate an advertisements (ads) per hour Index for each television channel or program still under consideration. The ads per hour Index may be the quotient of the average number of ads per hour on the channel or program under consideration divided by the average number of ads per hour on other channels or programs in the same category. The ads per page Index may be stored by the computer 100 in the central database 110.

In step 934, the computer 100 may calculate a past performance Index for each television program still under consideration. The past performance Index may be the quotient of a metric used to measure the past performance of a television channel or program used in an advertising campaign divided by a metric used to measure the performance of all other or a collection of other television channels or programs used in similar advertising campaigns. Examples of past performance metrics may include, but are not limited to additional sales generated by the advertisement, increase in likelihood to purchase generated by the advertisement and conversion rates, where a “conversion” may be a purchase, a donation, contacting a politician, or joining an online community. The past performance Index may be stored by the computer 100 in the central database 110.

In step 936, the computer 100 may determine which of the participating audience members qualify as being in an opposing group of participating audience members to which the targeted content is not to be directed. The opposing group may be defined as having attitude values which are the most dissimilar to those of the target group referenced in connection with step 912. As with the target group, the opposing group of participating audience members may be determined by using the computer 100 to determine one or more attitude values for each of the participating audience members. The determined attitude values for the participating audience members may then be compared by the computer 100 with a selected opposing attitude value threshold and/or an attitude value range. If the attitude value for a particular participating audience member satisfies the selected opposing attitude value threshold and/or range, then the participating audience member may be indicated to be part of the opposing group by the computer 100.

In step 938, the computer 100 may determine the projected monthly viewership metrics for each television channel or program watched by the participating audience members 304 in the opposing group for each month in the analysis period using the television viewing information 117. The projected viewership metrics determined for each channel or program may include the same metrics as referenced in connection with step 904, and may be influenced by the projection factors in the same manner as in step 904. The projected monthly viewership metrics for each channel or program viewed by the participating audience members 304 in the opposing group, as well as in the target group, may be stored by the computer 100 in the central database 110.

In step 940, the projected monthly viewership metrics determined in step 938 may be combined (i.e., summed) by the computer 100 in the same manner as set forth in connection with step 906. Discount factors may be applied to the monthly viewership metrics before combining them to account for the decreased value of viewership metrics that pertain to an earlier month. The combined monthly viewership metrics may be stored in the central database 110 by the computer 100.

In step 942, the opposing group reach of each television channel or program watched by the participating audience members 304 in the opposing group may be calculated by the computer 100 using the television viewing information 117. The opposing group reach may be the quotient of the number of projected viewers to the television channel or program by projected participating audience members in the opposing group divided by the total number of projected participating audience members in the opposing group for the analysis period. The opposing group reach of each channel or program may be stored by the computer 100 in the central database 110.

In step 944, the computer 100 may determine the number of participating audience members 304 in the opposing group that were viewers of each program or channel using the television viewing information 117. The number of participating audience members 304 in the opposing group who were viewers of each television program or channel may then be compared with a threshold number of viewers that is required not to be surpassed. The computer 100 may store an indication in the central database 110 of which television channels and programs are and/or are not to be considered further for the delivery of targeted content based on the outcome of this step.

In step 946, the computer 100 may calculate an opposing group Reach Index for each television channel or program still under consideration. The opposing group Reach Index may be the quotient of the opposing group reach for each channel or program determined in step 942 divided by the overall reach of each channel or program determined in step 908. The opposing group Reach Index may be stored by the computer 100 in the central database 110.

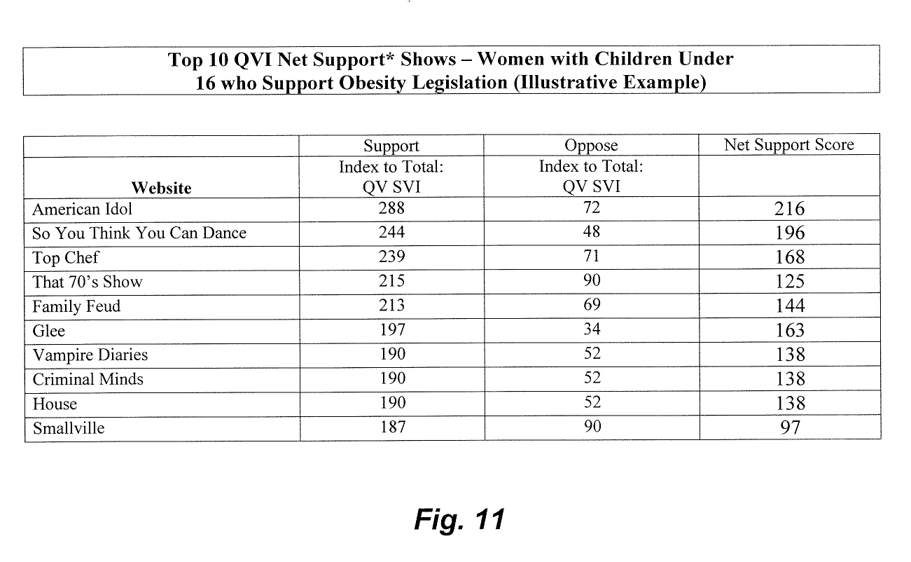

In step 948, a Net Support Score (NSS) may be calculated by the computer 100 by subtracting the opposing group Reach Index from the target group Reach Index or more preferably by dividing the opposing group Reach Index by the target group Reach Index. The Net Support Score may be used to identify television channels and/or programs for the delivery of targeted content which are (i) more likely to be watched by participating and non-participating audience members 304 and 310 who have attitude values (i.e., attitudes) that are similar to those of the target group, and (ii) less likely to be watched by participating and non-participating audience members who have attitude values (i.e., attitudes) that are similar to those of the opposing group. The NSS for each television channel or program may be ranked by the computer to identify those television channels and/or programs which are more favorable for the delivery of targeted content to participating and non-participating audience members. An example of the ranking of television channels by a NSS value is shown in FIG. 11 The NSS for each television program and an indication of the ranking of each television program may be stored by the computer 100 in the database 110.

In an alternative embodiment, the NSS may be calculated by multiplying the opposing group Reach Index by a minutes per unique visitor Index for the opposing group, and then subtracting or dividing the result from the result of the target group Reach Index multiplied by a minutes per unique viewer Index for the target group. The minutes per unique viewer Index for the target group may be determined by the computer 100 as stated in connection with step 920, above. The minutes per unique viewer Index for the opposing group may be determined by the computer 100 using the television viewing information 117 in the same manner as set forth for the target group in step 920. The (target group min/channel or program viewed) for each channel or program may be stored by the computer 100 in the central database 110.

In step 950, a Quality Visitation Index (QVI) value may be determined for each television channel or program by the computer 100 based on one or more of the attitude value, target group Reach Index, opposing group Reach Index, NSS, minutes watched per viewer Index, ads per hour Index, past performance Index, minutes per channel Index, and ads per channel Index. More specifically, in one embodiment of the present invention one or more of the foregoing indices and the NSS may be multiplied together to produce a QVI value. In another embodiment of the invention, one or more of the indices and the NSS may also be multiplied by a discretionary factor which gives the particular index or the NSS heavier or lighter weight in the QVI determination. In still another embodiment of the invention, the exponential value of one or more of the indices and the NSS may be multiplied together to produce a QVI value.

QVI may be determined using a regression model or other statistical technique The QVI value may be a function of the following variables:

1. Target Group Reach Index

2. Minutes watched per viewer Index

3. Information about the number of advertisements per hour

4. Past performance Index

5. Content quality index

6. Program content information (action, comedy, nature, etc.)

7. Show type (documentary, news, sitcom, movie, etc.)

8. Time of day

9. Day of week

The QVI value determined in step 950 may be compared with a threshold QVI value, a range of QVI values, or ranked against other QVI values for other television channels and programs to determine an optimal television channel and/or program for the delivery of targeted content. Examples of the ranking of television channel by QVI values are shown in FIG. 11. If the determined QVI value exceeds the threshold QVI value or falls within a prescribed QVI value range, the television channel or program in question may be selected for inclusion of content which is believed to be desirable to members of the target group. Alternatively, if the QVI value of a particular television channel or program ranks highly as compared to the QVI values of other television channels or programs, the television channel or program in question may be selected for inclusion of content which is believed to be desirable to members of the target group.

Once a television channel or television channels are selected to be used to deliver the targeted content to the participating and/or non-participating audience members based on the determined QVI value for the television channel(s), the content may be transmitted to one or more to one or more TV service providers 1120, and from the one or more TV service providers 1120 over the communications network 1100 to one or more of the audience member television monitors 320.

It will be apparent to those skilled in the art that variations and modifications of the present invention can be made without departing from the scope or spirit of the invention. For example, the particular formulas for determining QVI provided above are examples of preferred QVI formulas and should not be considered to be limiting of the invention. Different QVI formulas may be used without departing from the scope of the invention. Further, determinations made for television channels may be made for television programs, and vice versa, without departing from the intended scope of the present invention.

What is claimed is:

1. A method of transmitting content for viewing on a television display associated with an audience member based on attitude values determined for audience members who participate in a computer implemented survey, and television viewing information and demographic information for the audience members, the method comprising:
receiving at a central database survey response information transmitted over a computer network from participating audience member computers;
receiving at the central database television viewing information for the participating audience members;
receiving at the central database demographic information which is associated with the (i) participating audience members, and (ii) non-participating audience members from whom no survey response information is received;
determining information selected from the group consisting of: Value Orientation information, Purchase Category information, Purchase Orientation information, Brand Attribute information, Purchase Engagement information, Shopping Engagement information, Corporate Involvement information, Issue Question information, Political Orientation information, Voting History information, Party Affiliation information, and Level of Engagement information from the survey response information;
determining an attitude value for each of the participating audience members using a non-audience member computer based at least in part on one or more of the Value Orientation information, Purchase Category information, Purchase Orientation information, Brand Attribute information, Purchase Engagement information, Shopping Engagement information, Corporate Involvement information, Issue Question information, Political Orientation information, Voting History information, Party Affiliation information, and Level of Engagement information;
determining a Quality Visitation Index (QVI) value for a television channel or television program from the television viewing information and attitude values using the non-audience member computer;
providing content to TV service providers for the television channel or television program based on the QVI value for the television channel or television program; and
transmitting the content to a television display associated with one of said participating or non-participating audience members.

2. The method of claim 1, wherein the QVI value is based on a value selected from the group consisting of: a target group Reach Index, an opposing group Reach Index, a Net Support Score, and a minutes per program or channel Index.

3. The method of claim 1, wherein the QVI value is based on values selected from two or more of the group consisting of: a target group Reach Index, an opposing group Reach Index, a Net Support Score, and a minutes per program or channel Index.

4. The method of claim 1, further comprising the step of:
displaying the content on the display associated with one of said participating or non-participating audience members.

5. The method of claim 1, wherein the QVI value is determined at least in part from a computer implemented comparison of (i) a percentage of participating audience members associated with a selected attitude value who viewed the television channel or program in a selected time period, and (ii) a percentage of participating audience members who viewed the television channel or program in the selected time period.

6. The method of claim 5, wherein the percentage of participating audience members associated with a selected attitude value who viewed the television channel or program in a selected time period is determined based on a computer implemented comparison of (i) a number of participating audience members associated with the selected attitude value and who viewed the television channel or program in the selected time period, and (ii) a number of participating audience members who are associated with the selected attitude value.

7. The method of claim 1 further comprising the step of associating in the central database the attitude value, the survey response information, the television viewing information and the demographic information with an anonymous identifier for each participating audience member.

8. The method of claim 1 wherein the step of determining a QVI value includes the step of weighting the television viewing information for the participating audience members by a factor based on the demographic information associated with the participating audience members and the non-participating audience members.

9. The method of claim 8, wherein the demographic information is selected from the group consisting of: age, income, gender, census region, race, education level, religious affiliation, frequency of attendance at religious services, union participation, and frequency of Internet use information.

10. The method of claim 1 wherein the step of determining a QVI value includes the step of weighting the television viewing information for the participating audience members by a factor based on the time periods for which television viewing information is received.

11. The method of claim 10 wherein step of determining a QVI value includes the step of weighting the television viewing information for the participating audience members by a factor based on the amount of time between the receipt of survey response information and the determination of the QVI value.

12. The method of claim 1 wherein determining the QVI value comprises:
determining a net support score for the television channel or program based on the attitude values associated with the participating audience members; and
ranking the net support score for the television channel or program against the net support scores for other television channels or programs.

13. The method of claim 12 wherein determining the QVI value further comprises:
determining that a threshold number of participating audience members viewed the television channel or program in a predetermined period of time.

14. The method of claim 12 wherein determining the QVI value further comprises:
determining that a threshold number of participating audience members associated with the selected attitude value viewed the television channel or program in the predetermined period of time.

15. The method of claim 1 wherein the survey response information is received from one of said participating audience member computers on two different days more than thirty days apart.

16. The method of claim 1 wherein the attitude value is determined based at least in part on two or more of the Value Orientation information, Purchase Category information, Purchase Orientation information, Brand Attribute information, Purchase Engagement information, Shopping Engagement information, Corporate Involvement information, Issue Question information, Political Orientation information, Voting History information, Party Affiliation information, and Level of Engagement information

17. The method of claim 1 wherein the attitude value is determined based at least in part on three or more of the Value Orientation information, Purchase Category information, Purchase Orientation information, Brand Attribute information, Purchase Engagement information, Shopping Engagement information, and Corporate Involvement information.

18. The method of claim 17 wherein the participating audience members are associated with multiple attitude values.

19. The method of claim 1 wherein the step of transmitting the content to a television display associated with one of said participating or non-participating audience members is dependent in part on the demographic information associated with the participating audience members who viewed the television channel or program in the preselected time period.

20. The method of claim 19 wherein the step of providing the content to the television display based on the QVI value for the television channel or program is dependent in part on the demographic information associated with the non-participating audience members who viewed the television channel or program in the selected time period.

21. The method of claim 1 wherein the television viewing information relates to at least a multiple session period.

22. The method of claim 21 wherein the multiple session period comprises a more than thirty day period.

23. The method of claim 1 further comprising the steps of:
receiving additional survey response information from additional participating audience member computers more than thirty days after the survey response information is received from the participating audience member computers;
receiving at the central database the additional survey response information transmitted over the computer network from the additional participating audience member computers; and
determining the attitude value for each of the participating and additional participating audience members based on the survey response information and the additional survey response information.

24. A method of determining content for display on a television display associated with an audience member, the method comprising:
receiving at a central database survey response information transmitted over a computer network from participating audience member computers;
receiving at the central database television viewing information for the participating audience members;
receiving at the central database demographic information which is associated with the (i) participating audience members, and (ii) non-participating audience members from whom no survey response information is received;
determining information selected from the group consisting of: Value Orientation information, Purchase Category information, Purchase Orientation information, Purchase Engagement information, Brand Attribute information, Shopping Engagement information, Corporate Involvement information, Issue Question information, Political Orientation information, Voting History information, Party Affiliation information, and Level of Engagement information from the survey response information;
determining an attitude value for each of the participating audience members based at least in part on one or more of the Value Orientation information, Purchase Category information, Purchase Orientation information, Brand Attribute information, Purchase Engagement information, Shopping Engagement information, Corporate Involvement information, Issue Question information, Political Orientation information, Voting History information, Party Affiliation information, and Level of Engagement information;
determining a Quality Visitation Index (QVI) value for a television channel or program from the television viewing information and attitude values; and
providing content for display on the television channel or program based on the QVI value for the television channel or program.

25. The method of claim 24, wherein the QVI value is based on a value selected from the group consisting of: a target group Reach Index, an opposing group Reach Index, a Net Support Score, and a minutes per television channel or program Index.

26. The method of claim 24, wherein the QVI value is based on values selected from two or more of the group consisting of: a target group Reach Index, an opposing group Reach Index, a Net Support Score, and a minutes per television channel or program Index.

27. The method of claim 24, further comprising the step of:
displaying the content on the display associated with one of said participating or non-participating audience members.

28. The method of claim 24, wherein the QVI value is determined at least in part from a computer implemented comparison of (i) a percentage of participating audience members associated with a selected attitude value who viewed the television channel or program in a selected time period, and (ii) a percentage of participating audience members who viewed the television channel or program in the selected time period.

29. The method of claim 28, wherein the percentage of participating audience members associated with a selected attitude value who viewed the television channel or program in a selected time period is determined based on a computer implemented comparison of (i) a number of participating audience members associated with the selected attitude value and who viewed the television channel or program in the selected time period, and (ii) a number of participating audience members who are associated with the selected attitude value.

30. The method of claim 24 further comprising the step of associating in the central database the attitude value, the survey response information, the television viewing information and the demographic information with an anonymous identifier for each participating audience member.

31. The method of claim 24 wherein the step of determining a QVI value includes the step of weighting the television viewing information for the participating audience members by a factor based on the demographic information associated with the participating audience members and the non-participating audience members.

32. The method of claim 24 wherein the step of determining a QVI value includes the step of weighting the television viewing information for the participating audience members by a factor based on the time periods for which television viewing information is received.

33. The method of claim 24 wherein step of determining a QVI value includes the step of weighting the television viewing information for the participating audience members by a factor based on the amount of time between the receipt of survey response information and the determination of the QVI value.

34. The method of claim 24 wherein determining the QVI value comprises:
determining a net support score for the television channel or program based on the attitude values associated with the participating audience members; and
ranking the net support score for the television channel or program against the net support scores for other television channels or programs.

35. The method of claim 24 wherein determining the QVI value further comprises:
determining that a threshold number of participating audience members viewed the television channel or program in a predetermined period of time.

36. The method of claim 24 wherein determining the QVI value further comprises:
determining that a threshold number of participating audience members associated with the selected attitude value viewed the television channel or program in the predetermined period of time.

37. The method of claim 24 wherein the attitude value is determined based at least in part on two or more of the Value Orientation information, Purchase Category information, Purchase Orientation information, Brand Attribute information, Purchase Engagement information, Shopping Engagement information, Corporate Involvement information, Issue Question information, Political Orientation information, Voting History information, Party Affiliation information, and Level of Engagement information

38. The method of claim 24 further comprising the steps of:
receiving additional survey response information from additional participating audience member computers more than thirty days after the survey response information is received from the participating audience member computers;
receiving at the central database the additional survey response information transmitted over the computer network from the additional participating audience member computers; and
determining the attitude value for each of the participating and additional participating audience members based on the survey response information and the additional survey response information.
